(19) United States
(12) Patent Application Publication
(10) Pub. No.: US 2013/0211669 A1
(43) Pub. Date: Aug. 15, 2013

(54) AUTOMATIC AUTOMOTIVE USER PROFILE SELECTION

(71) Applicant: Matthew J. DePetro, Sunnyvale, CA (US)

(72) Inventor: Matthew J. DePetro, Sunnyvale, CA (US)

(73) Assignee: FUJITSU LIMITED, Kanagawa (JP)

(21) Appl. No.: 13/397,372

(22) Filed: Feb. 15, 2012

(51) Int. Cl. G06F 7/00

(52) U.S. Cl. 701/36; 701/1

(57) ABSTRACT

In accordance with some embodiments of the present disclosure, a method may include detecting at least one physical characteristic, the at least one physical characteristic comprising at least one of a physical characteristic of a user of the automobile and a physical characteristic of an item of the user's person. The method may also include determining at least one user-configurable environment setting for each of one or more components of the automobile based on the at least one physical characteristic detected. The method may further include applying the at least one user-configurable environment setting associated with each particular component of the one or more components.

### TECHNICAL FIELD

The present disclosure relates generally to automotive vehicles, more particularly, to automatic selection of user environment settings in an automobile.

### BACKGROUND

Increasingly automobiles have been configured with the ability to store a variety of environment settings (e.g., user preferences relating to seat position, steering wheel position, mirror positions, radio tuner presets, ventilation settings, etc.) for a particular user. Traditionally, users have been able to recall such settings in response to a manual indication from the user (e.g., manually pressing a button on a key fob associated with the vehicle, manually pressing a button or similar device in an automobile cabin, etc.). Upon recalling a setting, a computer or other intelligent system in the automobile may communicate signals to other components of the automobile in order to apply such environment settings (e.g., by adjusting the seat position via a motor, adjusting the steering wheel position via a motor, adjusting mirror position via a motor, tuning to a desired radio station, setting the ventilation system to a desired temperature, etc.).

### SUMMARY

In accordance with some embodiments of the present disclosure, a method may include detecting at least one physical characteristic, the at least one physical characteristic comprising at least one of a physical characteristic of a user of the automobile and a physical characteristic of an item of the user's person. The method may also include determining at least one user-configurable environment setting for each of one or more components of the automobile based on the at least one physical characteristic detected. The method may further include applying the at least one user-configurable environment setting associated with each particular component of the one or more components.

Technical advantages of the present disclosure may be readily apparent to one skilled in the art from the figures, description and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a block diagram of selected components of an example automobile, in accordance with embodiments of the present disclosure; and

FIG. 2 illustrates a flow chart of an example method of automatically applying a user profile selection in an automobile, in accordance with embodiments of the present disclosure.

### DETAILED DESCRIPTION

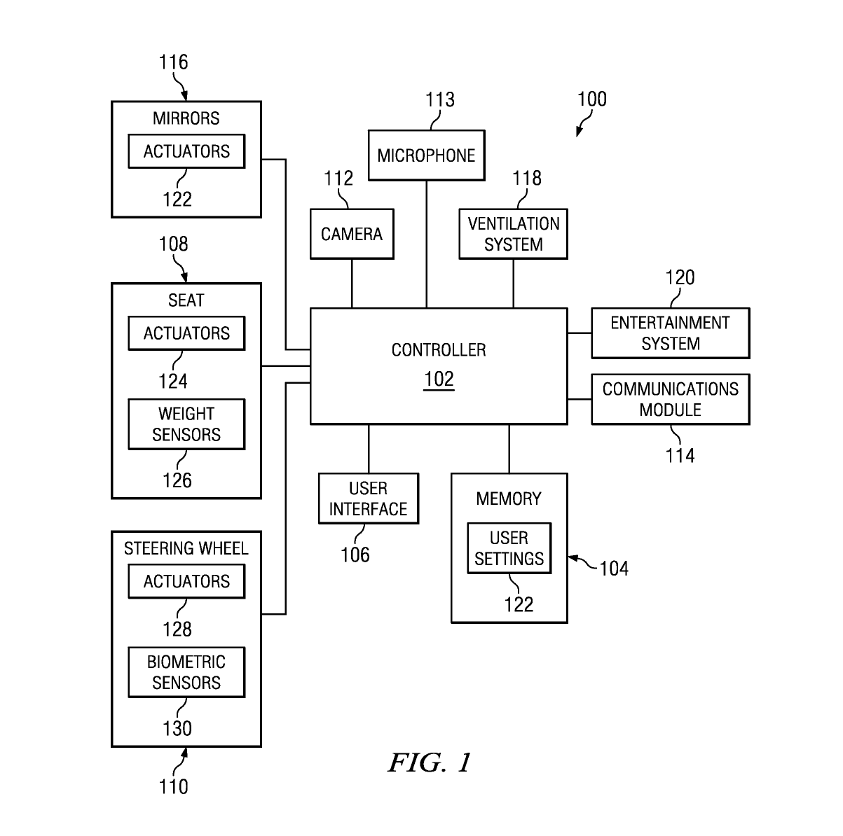

FIG. 1 illustrates a block diagram of selected components of an example automobile 100, in accordance with embodiments of the present disclosure. Automobile 100 may broadly represent any system, device, or apparatus configured or used to transport persons and/or cargo in whole or in part on land, including without limitation a passenger automobile (e.g., a car, truck, sport utility vehicle, van, bus, motorcycle, coach, etc.), a train, a trolley, an aircraft, a spacecraft, an amphibious watercraft, industrial equipment (e.g., a forklift, cart, etc.), and/or any other suitable vehicle. As depicted in FIG. 1, automobile 100 may include a controller 102, a memory 104, a user interface 106, one or more seats 108, a steering wheel 110, a camera 112, a microphone 113, a communications module 114, one or more mirrors 116, a ventilation system 118, and an entertainment system 120.

Controller 102 may be communicatively coupled to memory 104, user interface 106, seat 108, steering wheel 110, camera 112, communications module 114, mirrors 116, ventilation system 118, entertainment system 120, and/or other components of automobile 100. Controller 102 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, controller 102 may interpret and/or execute program instructions and/or process data stored in memory 104 and/or another component of automobile 100. In operation, controller 102 may receive from and/or communicate to other components of automobile 100 in order to identify a user based on received identifying characteristics of a user and control components of automobile 100 in order to apply user-specific environment settings associated with such components, as described in greater detail below.

Memory 104 may be electrically coupled to controller 102 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory. In certain embodiments, memory 104 may store user settings 122. User settings 122 may include a table, map, list, database, or other data structure setting forth individual users of automobile 100, identifying information for each such user, and/or environment settings for each user.

User interface 106 may be communicatively coupled to controller 102 and may include any system, device, or apparatus configured to receive input from a user to allow the user to control or manipulate automobile 100 and its various components and/or display user-readable output allowing automobile 100 to indicate effects of such user manipulation. For example, user interface 106 may include a display device, keyboard, keypad, and/or other devices. In operation, user interface 106 may receive or facilitate receipt of user input indicating a user's desired environment settings and/or identifying information.

Seat 108 may be communicatively coupled to controller 102 and may comprise a chair configured to seat a user during motion of automobile 100. As shown in FIG. 1, seat 108 may include one or more actuators 124. An actuator 124 may include any system, device, or apparatus (e.g., a motor), configured to, in response to signals received from controller 102 indicative of a user preference set forth in user settings 122, translate one or more portions of seat 108 to place seat 108 in a particular position. For example, one or more actuators 124 may affect a degree of incline, height, fore/aft position, and/or firmness of seat 108. As used herein, seat 108 may include a driver seat, passenger seat, rear seat, or any other seat within automobile 100.

As depicted in FIG. 1, seat 108 may also include one or more weight sensors 126. Weight sensors 126 may be configured to detect a weight 126 of a user seated in a seat 108, a height or the user, and/or a body frame type of such user. For example, in one embodiment, a single weight sensor 126 may determine an approximate weight of a user. In another embodiment, multiple weight sensors 126 may be distributed throughout the seat to determine a weight exerted by the user against the seat at each weight sensor 126, which may be indicative of a body frame type and/or height of the user. Such weight, height, and/or body frame type may be communicated from weight sensors 126 to controller 102 as identifying information associated with a user.

Steering wheel 110 may be communicatively coupled to controller 102 and may comprise any system, device, or apparatus configured to allow a user thereof to manipulate a steer direction of automobile 100. As shown in FIG. 1, steering wheel 100 may include one or more actuators 128. An actuator 128 may include any system, device, or apparatus (e.g., a motor), configured to, in response to signals received from controller 102 indicative of a user preference set forth in user settings 122, translate one or more portions of steering wheel 110 to place seat 110 in a particular position. For example, one or more actuators 128 may affect a degree of tilt, a height, and/or a steering wheel column length of steering wheel 110.

As depicted in FIG. 1, steering wheel 110 may also include one or more biometric sensors 130. A biometric sensor 130 may include any sensor configured to detect the presence of an identifying characteristic from the hands or fingers of a user engaged with the steering wheel (e.g., finger print sensor, palm vein sensor, etc.), which may indicate an identity of the user. Such detected biometric information may be communicated from biometric sensor 130 to controller 102 as identifying information associated with a user.

Camera 112 may be communicatively coupled to controller 102 and may include any imaging device configured to capture visual information regarding a user of automobile 100. For example, camera 112 may capture an image of a user and such image may be communicated to controller 102 as identifying information associated with a user. Upon receipt of such image, controller 102 may apply biometric techniques (e.g., facial recognition, determination of body frame type, height, etc.), to identify the user based on user settings 122 stored in memory 104.

Microphone 113 may be communicatively coupled to controller 102 and may include any acoustic-to-electric transducer or sensor that converts sound into an electrical signal. For example, microphone 113 may capture an audio recording of a voice of a user and such recording may be communicated to controller 102 as identifying information associated with a user. Upon receipt of such recording, controller 102 may apply voice recognition to identify the user based on user settings 122 stored in memory 104.

Communications module 114 may be communicatively coupled to controller 102 and may include any system, device, or apparatus configured to receive a transmission (e.g., via Wireless Fidelity, Bluetooth, Near-Field Communication, infrared, Radio-Frequency Identification, etc.) from an electronic device carried by or otherwise associated with a user (e.g., a cellular phone, personal digital assistant, tablet computer, etc.) identifying the electronic device, which may indicate an identity of the user. Such detected electronic device information may be communicated from communications module 114 to controller 102 as identifying information associated with a user.

One or more mirrors 116 may be communicatively coupled to controller 102 and may include reflective devices allowing a driver side views, a rear view, or any other suitable view of surroundings of automobile 100. As shown in FIG. 1, a mirror 116 may also include one or more actuators 132. An actuator 132 may include any system, device, or apparatus (e.g., a motor), configured to, in response to signals received from controller 102 indicative of a user preference set forth in user settings 122, translate one or more portions of a mirror 116 to place the mirror 116 in a particular position. For example, one or more actuators 132 may affect a degree of horizontal tilt and/or vertical tilt of a mirror.

Ventilation system 118 may be communicatively coupled to controller 102 and may include any suitable climate control system (e.g., air conditioning, heating, defrosting and defogging of windows, seat warmers, etc.). Ventilation system 118 may be configured to, in response to signals received from controller 102 indicative of a user preference set forth in user settings 122, apply operational parameters in accordance with the user preference. For example, based on user preference set forth in user settings 122, ventilation system 118 may control temperature, fan speed, enable or disable particular vents, adjust direction of airflow from vents, and/or other parameters.

Entertainment system 120 may be communicatively coupled to controller 102 and may include any suitable audio/visual system for providing audible and/or visual entertainment to an occupant of automobile 100. Entertainment system 120 may be configured to, in response to signals received from controller 102 indicative of a user preference set forth in user settings 122, apply operational parameters in accordance with the user preference. For example, based on user preference set forth in user settings 122, entertainment system 120 may program radio station presets associated with the user, tune a particular radio station, play media from a particular source (e.g., tuner, CD, DVD, auxiliary, etc.), set a particular volume, and/or other parameters.

In operation, one or more components of automobile may communicate identifying information regarding one or more users (e.g., automobile occupants) of automobile to controller 102. In response, controller 102 may read user settings 122 associated with such users from memory 104, and communicate signals indicative of user preferences to one or more components. In response to receipt of such signals, individual components may apply automobile environment settings in accordance with the user preferences. As used herein, “identifying information” may broadly include any physical characteristic of an individual (e.g., height, weight, biometric characteristics) and/or an item of such individual's person (e.g., electronic device carried by the individual) that may alone or in combination with other physical characteristics, identify a particular user. As used herein, an “environment setting” may broadly include any user-configurable preference or parameter related to any component or subsystem of an automobile (e.g., seat location, steering wheel location, mirror location, entertainment system settings, ventilation system settings, etc.). As used herein, “user” may broadly refer to any occupant of a vehicle, including a driver or passenger.

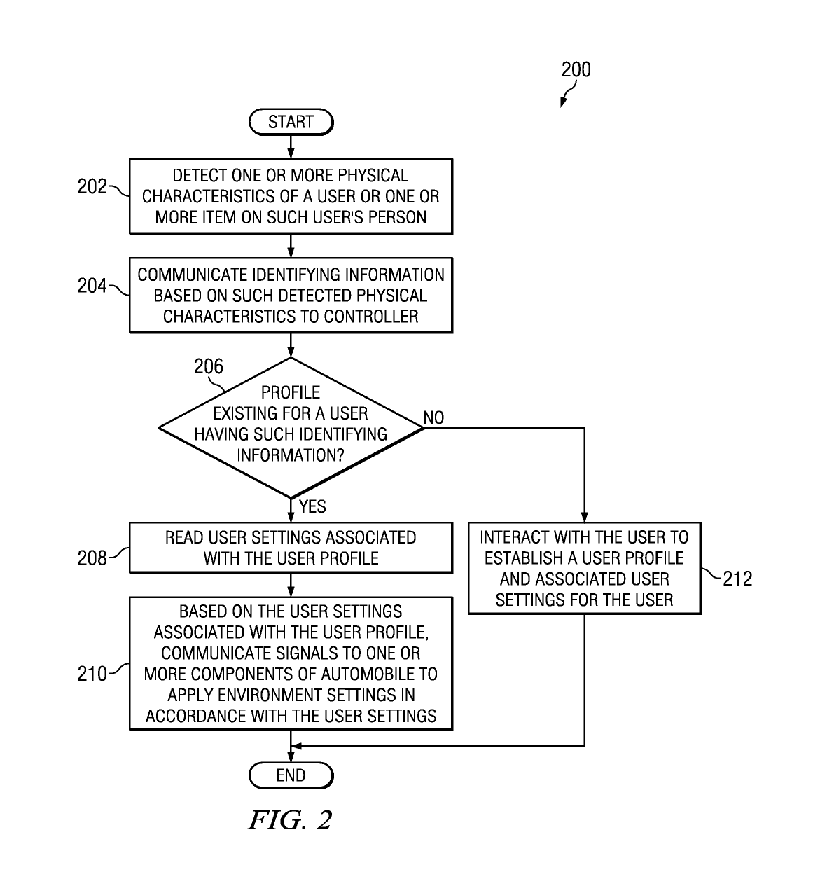

FIG. 2 illustrates a flow chart of an example method 200 of automatically applying a user profile selection in an automobile, in accordance with embodiments of the present disclosure. According to one embodiment, method 200 may comprise steps 202-212. As noted above, teachings of the present disclosure may be implemented in a variety of configurations of automobile 100. As such, the preferred initialization point for method 200 and the order of the steps 202-212 comprising method 200 may depend on the implementation chosen.

At step 202, one or more components of automobile 100 may detect one or more physical characteristics of a user or one or more item of such user's person. At step 204, the one or more components of automobile 100 may communicate identifying information based on such detected physical characteristics to controller 102.

At step 206, controller 102 may determine if a profile exists in user settings 122 for a user having such identifying information. If a profile does not exist, method 200 may proceed to step 212. If a profile does exist, method 200 may proceed to step 208.

At step 208, in response to a determination that a user profile exists, controller 102 may read user settings 122 associated with the user profile. At step 210, controller 102 may, based on the user settings 122 associated with the user profile, communicate signals to one or more components of automobile 100 such that the one or more components apply environment settings in accordance with the user settings 122 associated with the user profile. After completion of step 210, method 200 may end.

At step 212, in response to a determination that a user profile does not exist, controller 102 may, via user interface 106, interact with the user to establish a user profile and associated user settings for the user. After completion of step 212, method 200 may end.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using controller 102 and/or or any other system, device, or apparatus operable to implement method 200. In certain embodiments, method 200 may be implemented partially or fully in software and/or firmware embodied in computer-readable media.

A component of automobile 100 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible computer readable storage media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Herein, “each” refers to each member of a set or each member of a subset of a set.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. An automobile comprising:
one or more sensors each configured to detect a physical characteristic of at least one of a user of the automobile and an item of the user's person;
one or more components each having at least one user-configurable environment setting;
a controller communicatively coupled to the one or more sensors and the one or more components and configured to:
receive identifying information from each of the one or more sensors indicative of the at least one physical characteristic of the user;
based on the received identifying information, determining the at least one user-configurable environment setting for each of the one or more components; and
for each particular component of the one or more components, communicate information indicative of the at least one user-configurable environment setting associated with the particular component to the particular component.

2. An automobile according to claim 1, wherein each particular component is configured to apply the at least one user-configurable environment setting associated with the particular component in response to receipt of the information indicative of the at least one user-configurable environment setting.

3. An automobile according to claim 1, the one or more sensors comprising at least one of:
a weight sensor integral to a seat of the automobile;
a biometric sensor integral to a steering wheel of the automobile;
a camera; and
a communication module configured to receive identifying information regarding an electronic device carried by the user.

4. An automobile according to claim 1, the one or more user-configurable environment settings comprising:
a position of a seat of the automobile;
a position of a mirror of the automobile;
a position of a steering wheel of the automobile;
a parameter associated with a ventilation system of the automobile; and
a parameter associated with an entertainment system of the automobile.

5. An automobile according to claim 1, the at least one physical characteristic comprising at least one of:
a height of the user;
a weight of the user;
a body frame type of the user;
a biometric indicator of the user; and
identifying information associated with an electronic device carried by the user.

6. A method comprising:
detecting at least one physical characteristic, the at least one physical characteristic comprising at least one of a physical characteristic of a user of the automobile and a physical characteristic of an item of the user's person;
based on the at least one physical characteristic detected, determining at least one user-configurable environment setting for each of one or more components of the automobile; and
applying the at least one user-configurable environment setting associated with each particular component of the one or more components.

7. A method according to claim 6, wherein detecting the at least one physical characteristic comprises detecting the at least one physical characteristic by one or more sensors, the one or more sensors comprising at least one of:
a weight sensor integral to a seat of the automobile;
a biometric sensor integral to a steering wheel of the automobile;
a camera; and
a communication module configured to receive identifying information regarding an electronic device carried by the user.

8. A method according to claim 6, the one or more user-configurable environment settings comprising:
a position of a seat of the automobile;
a position of a mirror of the automobile;
a position of a steering wheel of the automobile;
a parameter associated with a ventilation system of the automobile; and
a parameter associated with an entertainment system of the automobile.

9. A method according to claim 6, the at least one physical characteristic comprising at least one of:
a height of the user;
a weight of the user;
a body frame type of the user;
a biometric indicator of the user; and
identifying information associated with an electronic device carried by the user.

10. An article of manufacture, comprising:
a computer readable medium; and
computer-executable instructions carried on the computer readable medium, the instructions readable by a processor, the instructions, when read and executed, for causing the processor to:
receive identifying information from each of one or more sensors of an automobile indicative of at least one physical characteristic of a user of the automobile;
based on the received identifying information, determining the at least one user-configurable environment setting for each of one or more components of the automobile; and
for each particular component of the one or more components, communicate information indicative of the at least one user-configurable environment setting associated with the particular component to the particular component.

11. An article of manufacture according to claim 10, the one or more sensors comprising at least one of:
a weight sensor integral to a seat of the automobile;
a biometric sensor integral to a steering wheel of the automobile;
a camera; and
a communication module configured to receive identifying information regarding an electronic device carried by the user.

12. An article of manufacture according to claim 10, the one or more user-configurable environment settings comprising:
a position of a seat of the automobile;
a position of a mirror of the automobile;
a position of a steering wheel of the automobile;
a parameter associated with a ventilation system of the automobile; and
a parameter associated with an entertainment system of the automobile.

13. An article of manufacture according to claim 10, the at least one physical characteristic comprising at least one of:
a height of the user;
a weight of the user;
a body frame type of the user;
a biometric indicator of the user; and
identifying information associated with an electronic device carried by the user.
